(19) United States
(12) Patent Application Publication
(10) Pub. No.: US 2026/0368129 A1
(43) Pub. Date: Nov. 19, 2026

(54) SoC FOR LOW POWER EDGE AI SUPPORT AND ELECTRONIC DEVICE INCLUDING SoC

(71) Applicants: Gwanak Analog Co., Ltd., Seoul (KR); Seoul National University R&DB Foundation, Seoul (KR)

(72) Inventors: Suhwan KIM, Seoul (KR); Namsoo KIM, Seoul (KR); Kyuseok KIM, Seongnam-si (KR); Kyoungwon LIM, Yongin-si (KR)

(73) Assignees: Gwanak Analog Co., Ltd., Seoul (KR); Seoul National University R&DB Foundation, Seoul (KR)

(21) Appl. No.: 19/130,244

(22) PCT Filed: Apr. 24, 2024
(86) PCT No.: PCT/KR2024/005515

§ 371 Date: May 15, 2025

(30) Foreign Application Priority Data
Nov. 16, 2023 (KR) 10-2023-0159544

(51) Int. Cl. G06F 15/78; G06F 7/544; G06F 13/42

(52) U.S. Cl. CPC G06F 15/7807; G06F 7/5443; G06F 13/4282

(57) ABSTRACT

An electronic device includes a system on chip (SoC), and a NAND flash connected to the SoC and configured to store a weight of an artificial neural network model and instructions, and the SoC includes a memory configured to store input data of the artificial neural network model, an interface configured to perform communication between the NAND flash and the SoC, and an accelerator configured to perform an artificial neural network operation between the input data obtained from the memory and the weight obtained through the interface.

### CROSS-REFERENCE TO RELATED APPLICATIONS

This application is the U.S. national phase of PCT Application No. PCT/US2023/012345, filed on Jun. 10, 2023, which claims the benefit of Korean Application No. 10-2023-0159544, filed on Nov. 16, 2023, the disclosures of which are incorporated in their entirety by reference herein.

### TECHNICAL FIELD

Embodiments relate to a system on chip (SoC) and an electronic device including an SoC, and more particularly, to an SoC for providing edge artificial intelligence (AI).

### BACKGROUND ART

Edge computing is a distributed computing paradigm that brings computing and data storage closer to devices collecting data. Therefore, compared to relying on a central device such as the cloud, edge computing does not have bandwidth and latency issues that affect application performance due to real-time data. Briefly, the edge computing executes processes locally, such as on a computer, an Internet of Things (IoT) device, or an edge server, instead of executing processes in the cloud. Bringing operations to a network edge reduces long-distance communication between clients and servers.

Edge artificial intelligence (AI) combines two technologies of edge computing and AI. Most AI processes are executed in the cloud, since the execution of a deep learning model today requires enormous computing capacity. However, the execution of AI in the cloud has disadvantages. For example, the execution of AI requires connection to the Internet and performance thereof may be affected by bandwidth and latency limitations.

Edge AI, also known as “on-device AI”, is a distributed computing paradigm in which AI algorithms are directly executed on the device using data generated by the device. When AI is executed on the edge of a local network, it is not necessary to connect the device to a centralized server, such as the internet or the cloud. However, current AI computing requires high power consumption and high computational cost.

The above description is information the inventor(s) acquired during the course of conceiving the present disclosure, or already possessed at the time, and is not necessarily art publicly known before the present application was filed.

### DISCLOSURE OF THE INVENTION

### Technical Solutions

An electronic device according to an embodiment may include a system on chip (SoC), and a NAND flash connected to the SoC and configured to store a weight of an artificial neural network model and instructions, and the SoC may include a memory configured to store input data of the artificial neural network model, an interface configured to perform communication between the NAND flash and the SoC, and an accelerator configured to perform an artificial neural network operation between the input data obtained from the memory and the weight obtained through the interface.

The memory may further include buffers configured to store the input data, and memory banks configured to load and store a portion of the weight from the interface according to the instruction.

The memory bank may include a first memory bank configured to store a first weight required for a corresponding operation cycle, and a second memory bank configured to store a second weight required for a next operation cycle of the corresponding operation cycle.

The accelerator may include a data selection unit configured to select first data and second data among outputs of the buffers and an output of the first memory bank.

The data selection unit may include a first multiplexer configured to select the first data among the outputs of the buffers and the output of the first memory bank, and a second multiplexer configured to select the second data among the outputs of the buffers and the output of the first memory bank.

The instructions may include a data alignment instruction, and the accelerator may include a data alignment unit configured to align the first data and the second data according to the data alignment instruction.

The first data may include consecutive data selected by the first multiplexer, the second data may include consecutive data selected by the second multiplexer, and the data alignment unit may include a first shifter configured to align the consecutive data selected by the first multiplexer, and a second shifter configured to align the consecutive data selected by the second multiplexer.

The accelerator may include an operation unit configured to perform the artificial neural network operation between the first data and the second data.

The instructions may include a convolution operation instruction, and the operation unit may be configured to perform a convolution operation between an output of the first shifter and an output of the second shifter according to the convolution operation instruction.

The operation unit may include a multiply-accumulate (MAC) configured to perform a MAC operation between the output of the first shifter and the output of the second shifter in one cycle according to the convolution operation instruction.

A number of buffers may be determined based on an algorithm corresponding to the artificial neural network operation.

The memory may include a static random access memory (SRAM).

The interface may include a quad serial peripheral interface (QSPI).

An SoC may include a memory configured to store input data of an artificial neural network model, an interface configured to perform communication with an external memory storing a weight of the artificial neural network model, and an accelerator configured to perform an artificial neural network operation between the input data obtained from the memory and the weight obtained through the interface according to instructions, the instructions may include a data alignment instruction and an operation instruction, and the accelerator may include a data alignment unit configured to align the input data and the weight according to the data alignment instruction, and an operation unit configured to perform an operation between the input data and the weight aligned by the data alignment unit.

### BRIEF DESCRIPTION OF DRAWINGS

FIG. 1A illustrates a block diagram of an electronic device according to an embodiment.

FIG. 1B illustrates a block diagram of a system on chip (SoC) according to an embodiment.

FIG. 2 illustrates a structure of an electronic device according to an embodiment . . . .

FIG. 3 is a diagram illustrating an SoC operation according to an embodiment.

FIG. 4 is a diagram illustrating a method of performing a multiply-accumulate (MAC) operation according to an embodiment.

FIG. 5 illustrates a block diagram of an electronic device according to various embodiments.

### BEST MODE FOR CARRYING OUT THE INVENTION

The following structural or functional descriptions of embodiments disclosed in the present disclosure are merely intended for the purpose of describing the embodiments and the embodiments may be implemented in various forms, the embodiments are not meant to be limited, but it is intended that various modifications, equivalents, and alternatives are also covered within the scope of the claims.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a,” “an,” and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The embodiments may be implemented as various types of products such as, for example, a data center, a server, a personal computer (PC), a laptop computer, a tablet computer, a smart phone, a television (TV), a smart home appliance, an intelligent vehicle, a kiosk, and a wearable device. Hereinafter, embodiments will be described in detail with reference to the accompanying drawings. In the drawings, like reference numerals are used for like elements.
[Project Unique ID] 1711193865
[Project Number] 2022-0-01013
[Ministry] Ministry of Science and ICT
[Project Management Institution] Institute of Information & Communications Technology Planning & Evaluation (IITP)
[Research Program] PIM Design Technology
[Research Project] Development of Edge-Oriented Compute-Enhanced DRAM PIM Semiconductor Technology
[Contribution Rate] 30/100
[Performing Institution] Seoul National University Industry-Academic Cooperation Foundation
[Research Period] Apr. 1, 2022-Dec. 31, 2025

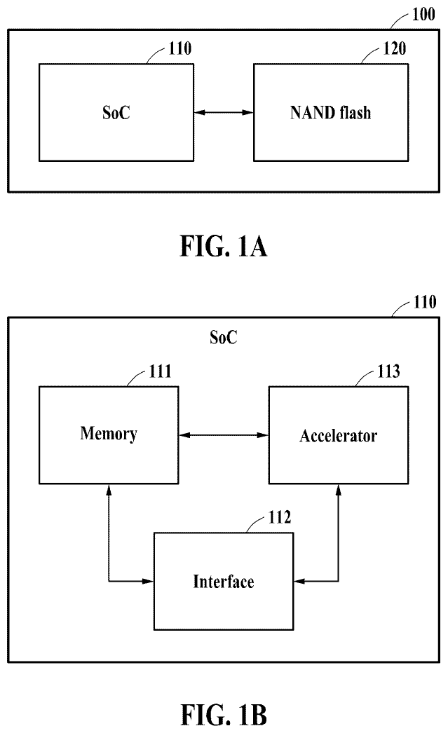

FIG. 1A illustrates a block diagram of an electronic device according to an embodiment.

An electronic device according to various embodiments may include at least one of, for example, a smartphone, a tablet PC, a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. According to various embodiments, the wearable device may include at least one of an accessory type (e.g., a watch, a ring, a bracelet, an anklet, a necklace, glasses, a contact lens, or a head-mounted device (HMD)), a fabric or clothing integrated type (e.g., an electronic clothing), a body-mounted type (e.g., a skin pad, or tattoo), or a bio-implantable type (e.g., an implantable circuit).

According to some embodiments, the electronic device may be a home appliance. The home appliance may include at least one of, for example, a TV, a digital video disk (DVD) player, an audio system, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, or an electronic photo frame.

In another embodiment, the electronic device may include at least one of various medical devices (e.g., various portable medical measuring devices (a blood glucose monitoring device, a heart rate monitoring device, a blood pressure measuring device, or a body temperature measuring device), a magnetic resonance angiography (MRA), a magnetic resonance imaging (MRI), a computed tomography (CT) machine, or an ultrasonic machine), a navigation device, a global navigation satellite system (GNSS), an event data recorder (EDR), a flight data recorder (FDR), a vehicle infotainment device, an electronic device for a ship (e.g., a navigation device for a ship or a gyro-compass), avionics, a security device, an automotive head unit, a robot for home or industry, an automatic teller's machine (ATM) in a bank, point of sales (POS) in a shop, or Internet of things (e.g., a light bulb, various sensors, an electric or gas meter, a sprinkler device, a fire alarm, a thermostat, a streetlamp, a toaster, a sporting goods, a hot water tank, a heater, or a boiler).

According to some embodiments, the electronic device may include at least one of a portion of furniture, a building/structure, an electronic board, an electronic signature receiving device, a projector, or various measuring instruments (e.g., water, electricity, gas, or radio wave measuring instruments, etc.). In various embodiments, the electronic device may be one of the various devices described above or a combination thereof. The electronic device according to some embodiments may be a flexible electronic device. In addition, the electronic device according to an embodiment is not limited to the devices described above and may include new electronic devices according to the development of technologies.

Hereinafter, the electronic device according to various embodiments will be described with reference to the accompanying drawings. Herein, the term “user” may indicate a person using an electronic device or a device (e.g., an artificial intelligence (AI) electronic device) using an electronic device.

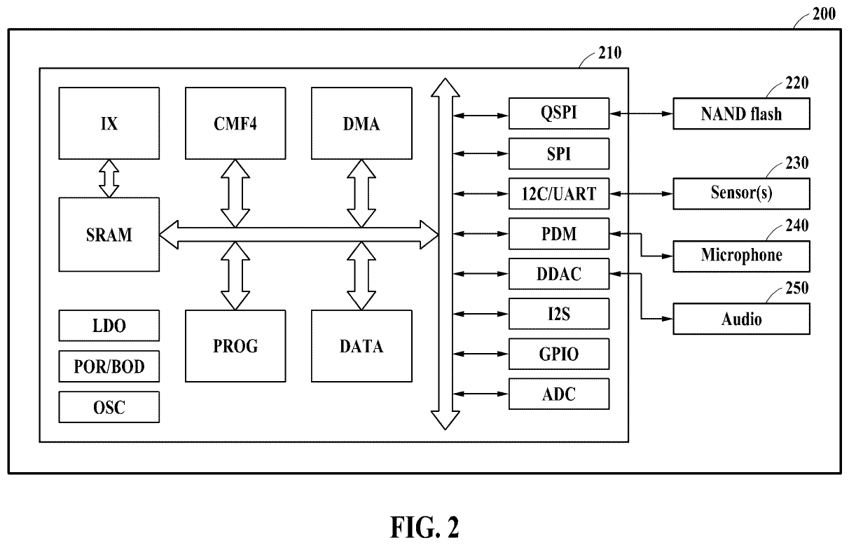

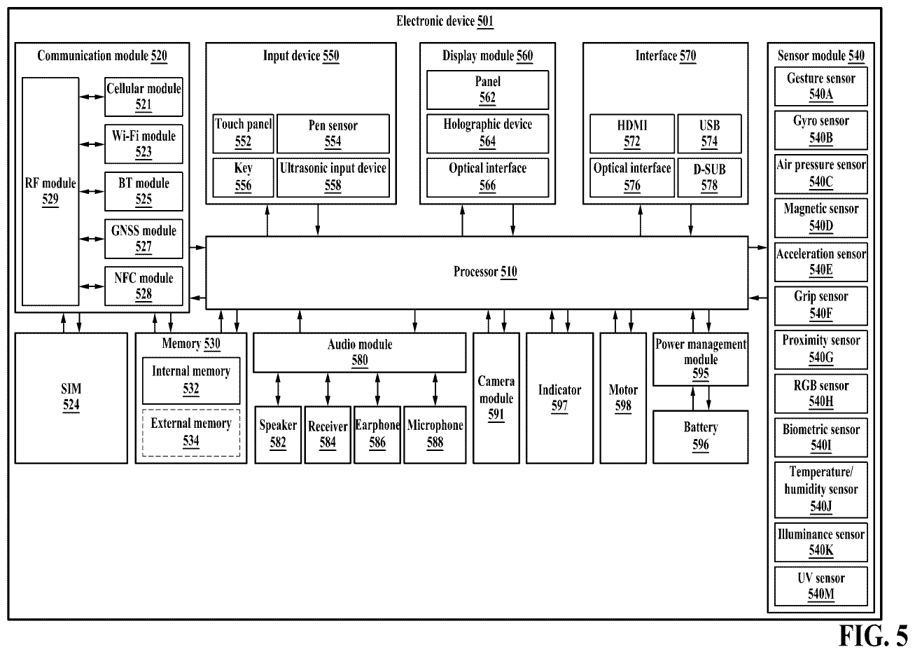

An electronic device 100 according to an embodiment may include edge AI including a system on chip (SoC) 110 and a NAND flash 120. For example, referring to FIG. 1A, the electronic device may include the SoC 110 and the NAND flash 120. The configuration of the electronic device shown in FIG. 1A is an example, and various modifications are possible to implement various embodiments disclosed in this document. For example, the electronic device may have the same configurations as an electronic device of FIG. 2A and an electronic device 501 shown in FIG. 5, or may be appropriately modified to utilize these configurations.

The electronic device 100 according to an embodiment may be edge AI that executes an AI algorithm locally on a hardware device using edge computing. The edge AI may perform an artificial neural network operation.

The electronic device 100 may perform, for example, Text-to-Speech (TTS) based on an artificial neural network model. The artificial neural network model for performing TTS may include a Text-to-Mel model which generates a text as a spectrogram, and a vocoder model which changes the generated spectrogram to actual sound waves (waveform). For example, the Text-to-Mel model may include a phoneme encoder, a duration predictor, and a Mel-decoder, and the vocoder model may be a high fidelity generative adversarial network (HiFi-GAN). However, the AI algorithm that may be executed in the electronic device 100 is not limited to the above description.

Below, an artificial neural network operation may refer to operations required to execute an AI algorithm, and may be referred to as a neural network operation. The neural network may refer to a general model that has an ability to solve a problem, where artificial neurons (nodes) forming the network through synaptic combinations change a connection strength of synapses through learning.

A neuron of the neural network may include a combination of weights or biases. The neural network may include one or more layers each including one or more neurons or nodes. The neural network may infer a desired result from a predetermined input by changing the weights of the neurons through learning.

The neural network may include a deep neural network (DNN). The neural network may include a convolutional neural network (CNN), a recurrent neural network (RNN), a perceptron, a multilayer perceptron, a feed forward (FF) network, a radial basis network (RBF), a deep feed forward (DFF) network, a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a GAN, a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and an attention network (AN).

The electronic device 100 according to an embodiment may include edge AI including the SoC 110 that performs an artificial neural network operation and the NAND flash 120. However, not all the illustrated components are essential. The electronic device 100 may be implemented by more components than the illustrated components, and the electronic device 100 may be implemented by less components.

Edge AI may include a chip that performs an artificial neural network operation, and a chip external memory storing weights and biases required for the artificial neural network operation and intermediate results of the operation. Since the amounts of the weights, the biases, and the intermediate results of the operation are very large, edge AI of the related art used a dynamic random-access memory (DRAM) as an external memory. In order to realize a fast operation, a high bandwidth is required, and data transmission of 16 bits or more is possible at a clock rate of 1 GHz for DDR5 and at a clock rate of 3 GHz for DDR5.

The electronic device 100 according to an embodiment may include the NAND flash 120 as an external memory. The NAND flash 120 has a lower bandwidth than that of a DRAM (e.g., 4-bit data at 100 MHz by interfacing with QSPI), and thus, efficient data supply is required for a fast operation. The NAND flash 120 may store weights and instructions required for the artificial neural network operations.

As will be described in detail below, the electronic device 100 according to an embodiment used the SoC 110 designed to enable efficient data supply, and new instructions for this were defined as in Table 1.

TABLE 1

| Instructions | Meaning |
|---|---|
| VP_CPY_CONST 0x00 | Constant copy operation |
| VP_CPY 0x01 | Copy operation |
| VP_ADD 0x02 | Addition operation |
| VP_MUL 0x03 | Multiplication operation |
| VP_ADD_CONST 0x04 | Constant addition operation |
| VP_MUL_CONST 0x05 | Constant multiplication operation |
| VP_ACC 0x06 | Accumulation operation |
| VP_ACC_SQUARE 0x07 | Square operation |
| VP_ADD_BIAS 0x08 | Bias operation |
| VP_CPY_DIFF_SEG 0x09 | Differentiation operation |
| VP_CONV1D_ALIGN 0x10 | Data alignment |
| VP_CONV1D 0x11 | Convolution operation |
| VP_TRANSPOSE1D 0x12 | Transpose operation |
| VP_RELU 0x13 | ReLu operation |

FIG. 1B illustrates a block diagram of an SoC according to an embodiment.

Referring to FIG. 1B, the SoC 110 according to an embodiment may include a memory 111, an interface 112, and at least one accelerator 113. However, not all the illustrated components are essential. The SoC 110 may be implemented by more components than the illustrated components, and the SoC 110 may be implemented by less components.

The memory 111 may store input data of an artificial neural network model. The input data according to an embodiment is an activation value, and may include an activation value of an intermediate layer and an activation value of an output layer. The memory 111 may be a buffer memory or a local memory. The memory 111 may be a static random access memory (SRAM).

The interface 112 according to an embodiment may relay a resource request or transfer from one component to another. The interface 112 may relay a resource request between the SoC 110 and the NAND flash 120. The interface 112 may transmit a data processing request between the SoC 110 and the NAND flash 120. The interface 112 may be connected to the memory 111 and the at least one accelerator 113.

The at least one accelerator 113 according to an embodiment may be a hardware component that performs some functions of the electronic device 100. Hereinafter, the accelerator may be referred to as a hardware accelerator, an inference accelerator, an interface accelerator (IX), or the like. The at least one accelerator 113 may perform some functions of the electronic device 100 more quickly than software implemented on a specific processor (e.g., a central processing unit (CPU)). For example, the at least one accelerator 113 may include at least one of a CPU, a graphics processing unit (GPU), a digital signal processor (DSP) or an instruction set architecture (ISA), and a graphics card (or a video card).

A structure of an electronic device in which various embodiments may be implemented is illustrated with reference to FIG. 2. The description provided with reference to FIGS. 1A and 1B may also apply to FIG. 2. The configuration of the electronic device shown in FIG. 2 is an example, and various modifications are possible to implement various embodiments disclosed in this document.

Referring to FIG. 2, an electronic device 200 according to an embodiment may include an SoC 210, a NAND flash 220, a sensor(s) 230, a microphone 240, and an audio 250. The SoC 210 according to an embodiment may include an IX, a SRAM, a low dropout (LDO), a power-on reset (POR)/brown-out detector (BOD), an oscillator (OSC), a micro-controller unit (MCU), a direct memory access (DMA), a QSPI, an SPI, I2C/UART, pulse-density modulation (PDM), DDAC, I2S, GPIO, ADC.

In terms of functions performed by each component, it may be understood that the IX, the SRAM, and the QSPI of FIG. 2 correspond to the accelerator 113, the memory 111, and the interface 112 of FIG. 1B, respectively. Hereinafter, a corresponding or repeated description will be omitted. The operations of the LDO, POR/BOD, OSC, MCU, DMA, SPI, I2C/UART, PDM, DDAC, I2S, GPIO, and ADC may be understood by those skilled in the art related to the present embodiment, and therefore, the detailed description thereof will be omitted.

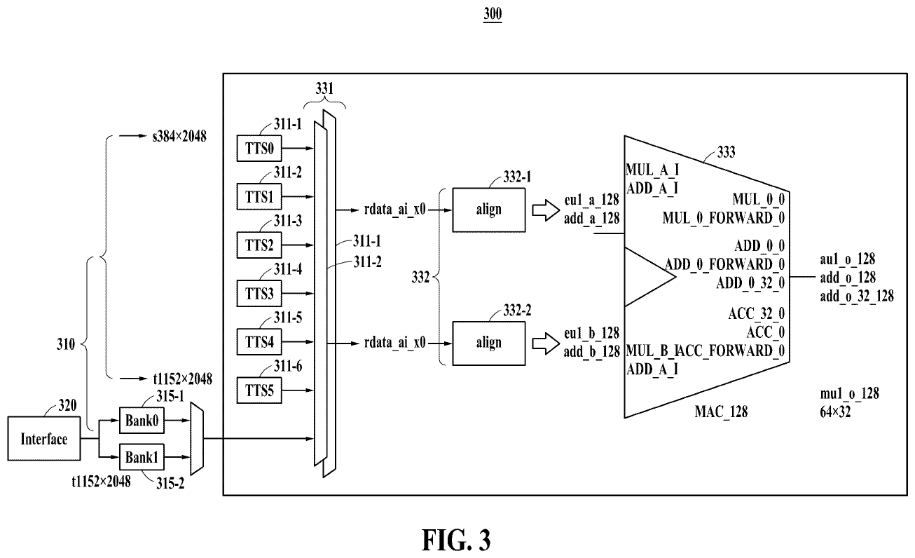

FIG. 3 is a diagram illustrating an SoC operation according to an embodiment. More specifically, FIG. 3 is a diagram illustrating a specific operation method of an SoC when a data alignment instruction and a convolution operation instruction are given. The description provided with reference to FIGS. 1A to 2 may be applied to FIG. 3 in the same manner.

Referring to FIG. 3, an SoC 300 according to an embodiment may include a memory 310, an interface 320, and an accelerator 330. The memory 310 according to an embodiment may include buffers 311-1 to 311-6 and memory banks 315-1 and 315-2. The accelerator 330 according to an embodiment may include a data selection unit 331, a data alignment unit 332, and an operation unit 333.

The term “unit” used herein may be, for example, a unit including one or a combination of two or more of hardware, software, or firmware. The “unit” may be interchangeably used with terms, such as, for example, a logic, a logical block, a component, or a circuit. The “unit” may be a minimum unit of an integrally formed component or a part thereof. The “unit” may be a minimum unit for performing one or more functions or a part thereof. The “unit” may be implemented mechanically or electronically. For example, the “unit” may include at least one of an application-specific integrated circuit (ASIC) chip, a field-programmable gate arrays (FPGAs), or a programmable-logic device for performing certain operations that are well known or to be developed in the future.

The interface 320 may store a first weight required for a corresponding operation cycle in a first memory bank 351-1, and store a second weight required for a next operation cycle of the corresponding operation cycle in a second memory bank 351-2 according to an instruction. In other words, the second memory bank 351-2 may store the weight and the bias for the next operation while performing the operation with the weight and the bias stored in the first memory bank 315-1. The weights stored in the first memory bank 315-1 and the second memory bank 351-2 may have a size of 1152-bit*2048-bit (depth×width).

The buffers 311-1 to 311-6 may store input data for artificial neural network operations. For example, the buffers 311-1 to 311-6 may store input data TTS0 to TTS5, respectively, for TTS operation. TTS0 to TTS5 may have a size of 384-bit*2048-bit (depth×width). widths of all internal signals may be 128×16-bit=2048-bit. In the artificial neural network operation according to the TTS algorithm described above, the six buffers 311-1 to 311-6 may be required for inputs, intermediate results, and final results. However, the number of buffers 311-1 to 311-6 is not limited.

The data selection unit 331 according to an embodiment may select first data (e.g., x0) and second data (e.g., x1) from outputs of the buffers 311-1 to 311-6 and an output of the memory banks 315-1 and 315-2.

The data selection unit 331 may read two operands (e.g., x0 and x1) simultaneously from a single port memory. x0 and x1 are 2048-bit operands, and may be 128 data with a 16-bit size. In order to read two operands simultaneously, the pieces of data must be in different areas, and therefore, the data selection unit 331 may include two multiplexers 331-1 and 331-2. The first multiplexer 331-1 may select the first data from the outputs of the buffers 311-1 to 311-6 and the output of the memory banks 315-1 and 315-2. The second multiplexer 331-2 may select the second data from the outputs of the buffers 311-1 to 311-6 and the output of the memory banks 315-1 and 315-2.

The data alignment unit 332 may align each of the first data and the second data according to a data alignment instruction. More specifically, the first data may include consecutive data (e.g., x0 and x0_d) selected by the first multiplexer 331-1. In the same manner, the second data may include consecutive data (e.g., x1 and x1_d) selected by the second multiplexer 331-2.

The data alignment unit 332 may include a first shifter 332-1 and a second shifter 332-2, the first shifter 332-1 may align the consecutive data selected by the first multiplexer 331-1, and the second shifter 332-2 may align the consecutive data selected by the second multiplexer 331-2. For example, the first shifter 332-1 may align 128 pieces of data among the two data, x0 and x0_d, which are read consecutively, and the first the shifter 332-1 may align 128 pieces of data among the two data, x1 and x1_d, which are read consecutively. This may also handle a case where the 128 pieces of data are not aligned exactly.

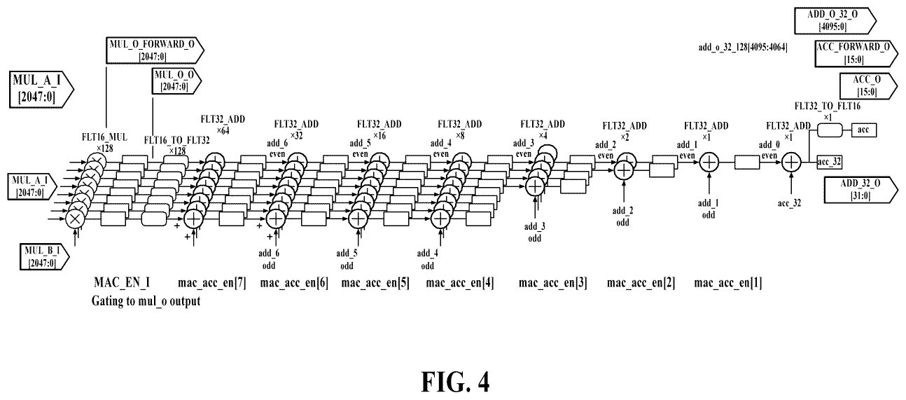

The operation unit 333 according to an embodiment may perform an artificial neural network operation between the first data and the second data. The operation unit 333 may perform a convolution operation between an output of the first shifter 332-1 and an output of the second shifter 332-2 according to a convolution operation instruction. The operation unit 333 may include a multiply-accumulate (MAC) that performs a MAC operation between the output of the first shifter 332-1 and the output of the second shifter 332-2 in one cycle. A method of performing the MAC operation according to an embodiment will be described in detail below with reference to FIG. 4. Although not shown in FIG. 3, the operation unit 333 according to an embodiment may include operation devices capable of performing a nonlinear operation (e.g., a ReLu operation) in addition to the convolution operation.

FIG. 4 is a diagram illustrating a method of performing a MAC operation according to an embodiment.

Referring to FIG. 4, the MAC operation according to an embodiment may be divided into a plurality of steps. For example, the MAC operation between 128 pieces of input data and weights may be divided into 9 steps. In a first step, a multiplication operation between the input data and the weights of 128 pieces of FP 16 precision may be performed. In an operation result of the first step, FP 16 precision may be changed to FP 32 precision. In order to minimize bits discarded in the process of the multiplication and addition, intermediate data may be expanded to 32 bits. Then, after completing a ninth step by repeating the addition in the form of an adder-tree, it may be changed back to FP 16. An electronic device according to an embodiment may perform the operation described above in one cycle.

FIG. 5 illustrates a block diagram of an electronic device according to various embodiments.

Referring to FIG. 5, an electronic device 501 may include, for example, all or some of the electronic device 100 illustrated in FIG. 1A. The electronic device 501 may include one or more processors (e.g., an application processor (AP)) 510, a communication module 520, a subscriber identification module (SIM) 524, a memory 530, a sensor module 540, an input device 550, a display module 560, an interface 570, an audio module 580, a camera module 591, a power management module 595, a battery 596, an indicator 597, and a motor 598.

The processor 510 may control a plurality of hardware or software components connected to the processor 510 by, for example, driving an operating system (OS) or an application program, and may perform various data processing and operations. The processor 510 may be implemented, for example, as an SoC (e.g., the SoC 110). According to an embodiment, the processor 510 may further include a graphic processing unit (GPU) and/or an image signal processor (ISP). The processor 510 may also include at least some of the components illustrated in FIG. 5 (e.g., a cellular module 521). In addition, the processor 510 may load instructions or data received from at least one of the other components (e.g., a non-volatile memory) to the volatile memory to process the same, and store a variety of data in the non-volatile memory.

The communication module 520 may include, for example, the cellular module 521, a Wi-Fi module 523, a Bluetooth module 525, a GNSS module 527 (e.g., a global positioning system (GPS) module, a GLONASS module, a BeiDou module, or a Galileo module), a near field communication (NFC) module 528, an MST module, and a radio frequency (RF) module 529.

The cellular module 521 may provide, for example, voice calls, video calls, text services, or Internet services through a communication network. According to an embodiment, the cellular module 521 may perform identification and authentication of the electronic device 501 within a communication network using a SIM (e.g., a SIM card) 529. According to an embodiment, the cellular module 521 may perform at least some of functions that may be provided by the processor 510. According to an embodiment, the cellular module 521 may include a communication processor (CP).

Each of the Wi-Fi module 523, the Bluetooth module 525, the GNSS module 527, the NFC module 528, or the MST module may include, for example, a processor for processing data transmitted and received through a corresponding module. According to some embodiments, at least some (e.g., two or more) of the cellular module 521, the Wi-Fi module 523, the Bluetooth module 525, the GNSS module 527, the NFC module 528, or the MST module may be included within a single integrated chip (IC) or an IC package.

The RF module 529 may, for example, transmit and receive communication signals (e.g., RF signals). The RF module 529 may include, for example, a transceiver, a power amp module (PAM), a frequency filter, a low noise amplifier (LNA), or an antenna. In another embodiment, at least one of the cellular module 521, the Wi-Fi module 523, the Bluetooth module 525, the GNSS module 527, the NFC module 528, and the MST module may transmit and receive RF signals through a separate RF module.

The SIM 529 may include, for example, a card including a SIM and/or an embedded SIM, and may include unique identification information (e.g., an IC card identifier (ICCID)) or subscriber information (e.g., an international mobile subscriber identity (IMSI)).

The memory 530 may include, for example, an internal memory 532 or an external memory 534. The internal memory 532 may include, for example, at least one of a volatile memory (e.g., a DRAM, a SRAM, or a synchronous DRAM (SDRAM)), a non-volatile memory (e.g., a one-time programmable read-only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash)), a hard disk drive (HDD), or solid state drive (SSD).

The external memory 534 may further include a flash drive, for example, a compact flash (CF), a secure digital (SD), a Micro-SD, a Mini-SD, an extreme digital (xD), a MultiMediaCard (MMC), or a memory stick. The external memory 534 may be functionally and/or physically connected to the electronic device 501 through various interfaces.

A security module 536 is a module that has a storage space with a relatively higher security level than the memory 530, and may be a circuit that ensures safe data storage and a protected execution environment. The security module 536 may be implemented as a separate circuit and may include a separate processor. The security module 536 may include, for example, an embedded secure element (eSE) that exists within a removable smart chip or an SD card, or is embedded within a fixed chip of the electronic device 501. In addition, the security module 536 may be driven by an OS different from the OS of the electronic device 501. For example, the security module 536 may operate based on a java card open platform (JCOP) OS.

The sensor module 540 may, for example, measure physical quantities or detect an operating state of the electronic device 501, and convert the measured or detected information into an electrical signal. The sensor module 540 may include, for example, at least one of a gesture sensor 540A, a gyro sensor 540B, an air pressure sensor 540C, a magnetic sensor 540D, an acceleration sensor 540E, a grip sensor 540F, a proximity sensor 540G, a color sensor 540H (e.g., a red, green, blue (RGB) sensor), a biometric sensor 540I, a temperature/humidity sensor 540J, an illuminance sensor 540K, or an ultra-violet (UV) sensor 540M. Additionally or alternatively, the sensor module 540 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 540 may further include a control circuit for controlling at least one sensor included therein. In some embodiments, the electronic device 501 may further include a processor configured to control the sensor module 540, as a part of the processor 510 or separately so that the sensor module 540 may be controlled while the processor 510 is in a sleep state.

The input device 550 may include, for example, a touch panel 552, a (digital) pen sensor 554, a key 556, or an ultrasonic input device 558. The touch panel 552 may use at least one of, for example, an electrostatic, pressure-sensitive, infrared, or ultrasonic method. Also, the touch panel 552 may further include a control circuit. The touch panel 552 may further include a tactile layer to provide a tactile response to a user.

The (digital) pen sensor 554 may be, for example, a part of the touch panel or may include a separate recognition sheet. The key 556 may include, for example, a physical button, an optical key, or a keypad. The ultrasonic input device 558 may detect ultrasonic waves generated from an input tool through a microphone (e.g., a microphone 588) and confirm data corresponding to the detected ultrasonic waves.

The display module 560 may include a panel 562, a holographic device 564, or a projector 566. The panel 562 may be implemented to be flexible, transparent, or wearable, for example. The panel 562 may be configured as one module with the touch panel 552. The holographic device 564 may display a three-dimensional image in the air using interference of light. The projector 566 may display images by projecting light onto a screen. The screen may be positioned, for example, inside or outside the electronic device 501. According to an embodiment, the display module 560 may further include a control circuit for controlling the panel 562, the holographic device 564, or the projector 566.

The interface 570 may include, for example, a high-definition multimedia interface (HDMI) 572, a universal serial bus (USB) 574, an optical interface 576, or D-subminiature (D-sub) 578. The interface 570 may include, for example, an mobile high-definition link (MHL) interface, an SD card/MMC interface, or an infrared data association (IrDA) standard interface.

The audio module 580 may, for example, bidirectionally convert sounds and electrical signals. The audio module 580 may process sound information input or output through, for example, a speaker 582, a receiver 584, an earphone 586, or the microphone 588.

The camera module 591 is, for example, a device capable of capturing still images and moving images, and according to an embodiment, may include one or more image sensors (e.g., a front sensor or a rear sensor), a lens, an ISP, or a flash (e.g., a light emitting diode (LED) or a xenon lamp).

The power management module 595 may, for example, manage the power of the electronic device 501. According to an embodiment, the power management module 595 may include a power management IC (PMIC), a charger IC, or a battery or fuel gauge. The PMIC may have a wired and/or wireless charging method. The wireless charging method may include, for example, a magnetic resonance method, a magnetic induction method, or an electromagnetic wave method, and may further include an additional circuit for wireless charging, for example, a coil loop, a resonant circuit, or a rectifier. The battery gauge may measure, for example, a remaining capacity of the battery 596, or a voltage, a current, or a temperature thereof during charging. The battery 596 may include, for example, a rechargeable battery and/or a solar battery.

The indicator 597 may indicate a specific state of the electronic device 501 or a part thereof (e.g., the processor 510), for example, a booting state, a message state, or a charging state. The motor 598 may convert an electrical signal into a mechanical vibration, and generate vibrations, haptic effects, or the like. Although not shown, the electronic device 501 may include a processing unit (e.g., a GPU) for mobile TV support. The processing unit for the mobile TV support may process media data according to standards such as digital multimedia broadcasting (DMB), digital video broadcasting (DVB), or MediaFLO™.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random access memory (RAM), flash memory, and the like. Examples of program instructions include both machine code, such as produced by a compiler, and files containing higher-level code that may be executed by the computer using an interpreter.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

1-13. (canceled)

14. An electronic device comprising:
a system on chip (SoC); and
a NAND flash connected to the SoC and configured to store a weight of an artificial neural network model and instructions,
wherein the SoC comprises:
a memory configured to store input data of the artificial neural network model;
an interface configured to perform communication between the NAND flash and the SoC; and
an accelerator configured to perform an artificial neural network operation between the input data obtained from the memory and the weight obtained through the interface.

15. The electronic device of claim 14, wherein the memory further comprises:
buffers configured to store the input data; and
memory banks configured to load and store a portion of the weight from the interface according to the instruction.

16. The electronic device of claim 15, wherein the memory bank comprises:
a first memory bank configured to store a first weight required for a corresponding operation cycle; and
a second memory bank configured to store a second weight required for a next operation cycle of the corresponding operation cycle.

17. The electronic device of claim 16, wherein the accelerator comprises a data selection unit configured to select first data and second data among outputs of the buffers and an output of the first memory bank.

18. The electronic device of claim 17, wherein the data selection unit comprises:
a first multiplexer configured to select the first data among the outputs of the buffers and the output of the first memory bank; and
a second multiplexer configured to select the second data among the outputs of the buffers and the output of the first memory bank.

19. The electronic device of claim 18, wherein
the instructions comprise a data alignment instruction, and
the accelerator comprises a data alignment unit configured to align the first data and
the second data according to the data alignment instruction.

20. The electronic device of claim 19, wherein
the first data comprises consecutive data selected by the first multiplexer,
the second data comprises consecutive data selected by the second multiplexer, and
the data alignment unit comprises:
a first shifter configured to align the consecutive data selected by the first multiplexer; and
a second shifter configured to align the consecutive data selected by the second multiplexer.

21. The electronic device of claim 20, wherein the accelerator comprises an operation unit configured to perform the artificial neural network operation between the first data and the second data.

22. The electronic device of claim 21, wherein
the instructions comprise a convolution operation instruction, and
the operation unit is configured to perform a convolution operation between an output of the first shifter and an output of the second shifter according to the convolution operation instruction.

23. The electronic device of claim 22, wherein the operation unit comprises a multiply-accumulate (MAC) circuit configured to perform a MAC operation between the output of the first shifter and the output of the second shifter in one cycle according to the convolution operation instruction.

24. The electronic device of claim 15, wherein a number of buffers is determined based on an algorithm corresponding to the artificial neural network operation.

25. The electronic device of claim 14, wherein the memory comprises a static random access memory (SRAM).

26. The electronic device of claim 14, wherein the interface comprises a quad serial peripheral interface (QSPI).

27. A system on chip (SoC) comprising:
a memory configured to store input data of an artificial neural network model;
an interface configured to perform communication with an external memory storing a weight of the artificial neural network model; and
an accelerator configured to perform an artificial neural network operation between the input data obtained from the memory and the weight obtained through the interface according to instructions,
wherein the instructions comprise a data alignment instruction and an operation instruction, and
the accelerator comprises a data alignment unit configured to align the input data and the weight according to the data alignment instruction; and
an operation unit configured to perform an operation between the input data and the weight aligned by the data alignment unit.
